(19) United States
(12) Patent Application Publication
(10) Pub. No.: US 2026/0258690 A1
(43) Pub. Date: Sep. 3, 2026

(54) ROBOTIC DOOR OPENER SYSTEM WITH SMART AUTOMATIC SPRING-LOADED WHEEL AND METHOD THEREOF

(71) Applicant: Prehensile Technologies, LLC, West Lafayette, IN (US)

(72) Inventors: JEFFREY ACKERMAN, Arvada, CO (US); BRADLEY DUERSTOCK, West Lafayette, IN (US); AUSTIN TOMSON, West Lafayette, IN (US); SEVERN SWIFT, San Francisco, CA (US); PHILLIP BELL, Battleground, IN (US)

(73) Assignee: Prehensile Technologies, LLC, West Lafayette, IN (US)

(21) Appl. No.: 19/554,573

(22) Filed: Mar. 2, 2026

Related U.S. Application Data
(60) Provisional application No. 63/765,239, filed on Feb. 28, 2025.

(51) Int. Cl. E05F 15/624

(52) U.S. Cl. CPC E05F 15/624; E05Y 2400/44; E05Y 2400/45; E05Y 2400/554; E05Y 2400/56; E05Y 2400/612; E05Y 2400/654; E05Y 2400/851; E05Y 2600/46

(57) ABSTRACT

A door opening system and apparatus comprising a motorized wheel that is spring-loaded with a linear actuator to maintain contact with any ground surface so the wheel can provide consistent traction force on the floor to pull or push a door open or closed with the required force. A controller can provide an opening operation that can include a timed opening mode where the door stays open for an adjustable amount of time and a toggle mode where the door opener keeps the door open until it receives a signal to close the door. The controller can utilize an algorithm for detecting and determining spring stiffness, spring deflection, and a coefficient of friction to calculate a required traction force and calibrates the biasing means deflection such that the wheel slips on the ground surface when an applied force exceeds a target door opening force, providing an inherent safety mechanism.

### CROSS-REFERENCE TO RELATED APPLICATION

This application claims priority to U.S. Provisional Patent Application No. 63/765,239 filed 28 Feb. 2025, to the above-named inventors, and is herein incorporated by reference in its entirety.

### FIELD OF THE INVENTION

This invention relates generally a method and apparatus to automate the opening of a hinged or sliding door. More particularly, the invention relates to a mechatronic device configured to open doors automatically.

### BACKGROUND

Existing automatic door opener solutions all look similar. These systems attach to the top of a door and an adjacent wall or door frame to open and close a door. They are essential to provide independent access through doors for people with disabilities that are unable to reliably open a door by themselves. Automatic doors are required for many public door entrances by the Americans with Disabilities Act (ADA), but these regulations don't apply to a user's home. Existing automatic door opener solutions can be installed professionally for an estimated $2,000-$4,000 (including labor). This installation cost is prohibitive for most people with disabilities, so most users will choose to automate the minimum number of doors in their home (typically 1 door). This necessary decision makes a user's home significantly less accessible to them daily. It can also be unsafe in the case of an emergency when quick mobility and egress is required, such as during a fire.

The typical design of an automatic door opener is an overhead device mounted to the top of a door frame with a motorized linkage mechanism to open the door. The main issues with these conventional designs are that they are expensive to install, are difficult to install with multiple mounting locations on the door and door frame or wall, require an electrician to wire them into the internal building AC wiring, require a very high torque motor and gearbox to open the door because the door lever arm is not mechanically advantageous close to the door hinge, and are hard to open normally with the motor off due to friction inside of the mechanism (friction in gearbox and linkages). The connection between most door frames and walls would have to be reinforced to support the forces to install and support conventional automatic door opener mechanisms. They are also difficult to install because electrical wiring must be embedded into the wall or door frame to connect to the building's AC power.

In addition, typical spring-loaded door latches prevent automatic doors from working because the latch blocks the motion of the door when it's closed. Therefore, these conventional automatic door opener installations need to install their own electrically controlled latches in the door frame or doorknobs in the door to engage a latch when the door should stay closed and disengage the latch when the automatic door is opened. Most automatic doors require the electrically controlled latch to be installed with the door, which requires a separate electrical connection through the door frame.

It is very difficult for someone with no or limited strength, dexterity, or range of motion in their hands and arms to open doors. There exists a need for a robotic device that enables the user to independently deploy, position, and open a door.

There exists a need for a new door opening mechanism that provides a more cost-effective and retrofitting solution to existing doors. Additionally, there is a need for a device to be customizable to adapt to engage or disengage in situations normal door operation is desired. Furthermore, there is a need for a new door opening mechanism and system that addresses the practical challenges of routing power and communication wiring between the door opening apparatus and its connected peripherals, as well as being capable of retrofit installations on existing doors.

### BRIEF SUMMARY OF THE INVENTION

In one aspect, this disclosure is related to an automatic door opener that can be retrofitted to any general hung swinging door. The door opening apparatus can include a housing, a drive assembly, and a controller.

In another aspect, the present disclosure is related to a door opening system comprising a door opening apparatus mountable to a door. The apparatus includes a housing configured to be coupled to the door, a biasing means, and a linear actuator configured to actively pre-tension the biasing means by moving between a first position and a second position. A wheel assembly is coupled to the linear actuator and is movable between a retracted position spaced from a ground surface and an engaged position in contact with the ground surface. A drive motor is configured to rotate a wheel of the wheel assembly around an axis. A linear position sensor is configured to monitor, in real time, an extension position of the linear actuator. A controller comprising a microprocessor and a memory is communicatively coupled to the linear actuator, the drive motor, and the linear position sensor. The controller is configured to calculate a required traction force for opening or closing the door based on at least a spring stiffness of the biasing means, a deflection of the biasing means controlled by the linear actuator, and a coefficient of friction between the wheel and the ground surface using a physics-based algorithm stored in the memory. The controller commands the linear actuator to adjust the deflection of the biasing means to achieve the calculated required traction force. The controller further calibrates the deflection of the biasing means such that the wheel slips on the ground surface when a force applied to the door by the wheel exceeds a target door opening force, thereby preventing the apparatus from applying excessive force against a person or obstacle.

A physics-based algorithm stored on the memory can utilize Hooke's Law (Fs=k·δx) in conjunction with a friction force equation (Ff=μ·k·δx) to determine a motor torque (T=μ·k·δx·r) and a door pulling force (F=μ·k·δx), where k is the spring stiffness, δx is the spring deflection, μ is the coefficient of friction, and r is a wheel radius. A controller can be further configured to dynamically adjust the spring downforce during operation by periodically commanding the linear actuator to push downward against the biasing means, measuring an electrical current drawn by the linear actuator, correlating the measured current to a known force-current relationship to determine a current spring force, and adjusting the linear actuator position to achieve a target current value corresponding to a desired spring force. In a further refined embodiment, a load cell force sensor is positioned at the top or bottom of the biasing means and configured to provide direct, continuous measurement of the spring force in real time, and the controller uses load cell data in a closed-loop feedback system to command the linear actuator to maintain a desired spring force.

In another aspect, the present disclosure is related to a door opening apparatus comprising a housing configured to be mounted to a door, a spring-loaded wheel assembly comprising a biasing means, a linear actuator, and a wheel, and a drive motor configured to rotate the wheel. An inertial measurement unit (IMU) is configured to continuously monitor the door's angular position relative to a closed position and angular velocity. A controller communicatively coupled to the drive motor and the IMU is configured to detect, via the IMU, a sudden deceleration or deviation from an expected angular speed profile during a door opening or closing operation, and in response, stop the drive motor to prevent the door from applying force against a person or obstacle. The controller is further configured to detect, via the IMU, that a user is pushing the door in an opening direction while the apparatus is engaged, and in response, drive the wheel motor to assist the user in opening the door to a maximum angle limit. The controller is also configured to detect, via the IMU, that a user is pushing the door in a closing direction, and in response, drive the wheel motor to assist the user in closing the door to the fully closed position.

In another aspect, the present disclosure is related to a door opening system comprising a door opening apparatus configured to be mounted to a door. The apparatus includes a housing, a spring-loaded wheel assembly, a drive motor, a controller, and a power supply interface. At least one peripheral module is selected from the group consisting of a dedicated unlatching unit configured to actuate a door latch mechanism, a handle-based unlatching mechanism configured to actuate a door handle or lever, and a wired electronic deadbolt. A wiring path is routed along or through the door from the door opening apparatus to the at least one peripheral module. The door opening apparatus serves as a central power distribution hub, distributing continuous electrical power from a primary power source through the wiring path to the at least one peripheral module, and further includes an internal backup battery configured to provide power to the at least one peripheral module upon interruption of the primary power source. The controller is configured to send control signals through the wiring path to the at least one peripheral module to coordinate latching and unlatching operations with door opening and closing sequences. Bidirectional communication can be established between the controller and the at least one peripheral module through the wiring path. The at least one peripheral module is configured to report status information including a locked or unlocked state, latch engagement confirmation, battery backup status, and fault conditions back to the controller. The controller may verify that the latch has been disengaged before initiating a door opening operation and confirm that the deadbolt has been engaged after a door closing operation. The at least one peripheral module may be interchangeably couplable to the door opening apparatus through a standardized wiring interface, enabling end users to configure a customized door automation solution by selecting and combining peripheral modules.

In another aspect, the present disclosure is related to a door opening apparatus and system. An exemplary embodiment of an apparatus of the present disclosure has a motorized wheel that is spring-loaded with a linear actuator to maintain contact with any ground surface so the wheel can provide consistent traction force on the floor to pull or push a door open or closed with the required force. The door opener can have a timed opening mode where the door stays open for an adjustable amount of time and a toggle mode where the door opener keeps the door open until it receives a signal to close the door. When the system is not in use, the drive wheel can be moved to a second position off the ground so that the mechanism provides no resistance to opening just like a normal door without a door opener.

The apparatus and system of the present disclosure can be placed below the door handle for maximum mechanical advantage by screwing it into the door, clamping it against the door, or taping/velcroing to the door. Various interfaces can be used to control this system (i.e., wired, or wireless switches, key fobs, motion sensors, app control, voice control, etc.) and sensors are included that prevent it from hitting doors and other obstacles. The system of the present disclosure can have a power source 800 that can include but is not limited to batteries, a wall plug, or wired into the building power. Additionally, in some exemplary embodiments, a system 1 of the present disclosure can further include a include a latch kit that blocks or inhibits existing spring-loaded door latch from springing forward within a latch plate. This embodiment can provide some resistance to prevent the door from opening unintentionally but without full latching and requiring a user to turn the knob. In other exemplary embodiments, the latching functionality of keeping a door closed can be replaced by using a small magnetic latch using a magnet and a steel plate.

A system of the present disclosure can additionally include peripheral components and subsystem. The system can be directly and operatively couplable to peripherals, providing integration with an electronic deadbolt or latch via wired or wireless communication for total door access control. The system may further comprise internal or exterior door wiring that routes directly from the door opening apparatus to an unlatching unit and/or a wired or wireless remotely operable electronic deadbolt. Where the door opening apparatus act as the power source for the entire door ecosystem, the deadbolt and unlatching mechanisms are able to always receive power and do not require individual power inputs. This eliminates the need to monitor and replace separate batteries in electronic deadbolts. The larger door opening apparatus unit provides one backup battery for the entire system in case of power failure.

As an alternative to retrofit of existing doors, this door opening apparatus can be integrated into an entire replacement door system with an electronic deadbolt and/or latch with embedded wiring to create a swap-out “Smart Door” solution. Compared to existing automatic door openers, this system is more compact, easier to install mechanically and electrically, more cost effective, and can be turned 90 degrees to open sliding/barn doors/pocket doors.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

The concepts described in the present disclosure are illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. The detailed description particularly refers to the accompanying figures in which:

FIG. 1A is a front view of an exemplary embodiment of the opener apparatus of the present disclosure in a first position.

FIG. 1B is a front view of an exemplary embodiment of the opener apparatus of the present disclosure in a second position.

FIG. 2A is an illustration of an exemplary embodiment door opening apparatus of the present disclosure coupled to a door in a first door position.

FIG. 2B is an illustration of an exemplary embodiment door opening apparatus of the present disclosure coupled to a door in a second door position.

FIG. 3A is an illustration of an exemplary embodiment door opening apparatus of the present disclosure coupled to a door in a first door position further communicatively coupled to a door handle apparatus.

FIG. 3B is an illustration of an exemplary embodiment door opening apparatus of the present disclosure coupled to a door in a second door position further communicatively coupled to a door handle apparatus and locking apparatus with an external power source.

FIG. 3C is an illustration of an exemplary embodiment door opening apparatus of the present disclosure coupled to a door in a second door position further communicatively coupled to a door handle apparatus and locking apparatus with an integrated power source into the door.

FIG. 4A is i a system diagram of an exemplary embodiment of the door opening apparatus of the present disclosure.

FIG. 4B is a system diagram of an exemplary embodiment of the door opening apparatus of the present disclosure having a linear actuator.

FIG. 4C is a system diagram of an exemplary embodiment of the door opening apparatus of the present disclosure including additional components and subsystems.

FIG. 5 is an illustration of a method of operation of an exemplary embodiment of a door opening apparatus of the present disclosure.

FIG. 6A is an illustration of a latch blocker of the present invention.

FIG. 6B is an illustration of a spring latch blocker with spring door interference plate.

FIG. 7 is an illustration of various forces acting on a motorized wheel of an exemplary embodiment of the door opening apparatus of the present disclosure.

FIG. 8 is a system diagram of an exemplary embodiment of the door opening apparatus of the present disclosure coupled to a latching peripheral, showing power flowing from the main building/backup battery to the door opener, to the latching peripheral, and to the deadbolt.

FIG. 9A is a perspective view illustration of a mounting plate of an exemplary embodiment of the present disclosure, showing the surface area for tape, the screw holes, and the specific pry-off/removal leverage handle features.

FIG. 9B is a front view illustration of a mounting plate of an exemplary embodiment of the present disclosure coupled to the door opener apparatus coupled to the door.

FIG. 10A is a perspective view illustration of a clamp mount of an exemplary embodiment of the present disclosure, showing the adjustable screws and the rubber feet.

FIG. 10B is a front cross-section view illustration of a clamp mount of an exemplary embodiment of the present disclosure installed to the door opener, showing how the rubber feet push against the door surface and wrap under the side/bottom of the door.

FIG. 10C is a perspective view illustration of a clamp mount of an exemplary embodiment of the present disclosure installed to the door opener apparatus coupled to the door.

### DETAILED DESCRIPTION OF THE INVENTION

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the present disclosure.

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s), or step(s), to the objective(s), spirit, or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the terms “front,” “back,” “rear,” “upper,” “lower,” “right,” and “left” in this description are merely used to identify the various elements as they are oriented in the FIGS, with “front,” “back,” and “rear” being relative to the apparatus. These terms are not meant to limit the elements that they describe, as the various elements may be oriented differently in various applications.

As used herein, the term “coupled” means the joining of two members directly or indirectly to one another. Such joining may be stationary in nature or movable in nature. Such joining may be achieved with the two members, or the two members and any additional intermediate members being integrally formed as a single unitary body with one another or with the two members or the two members and any additional intermediate members being attached to one another. Such joining may be permanent in nature or alternatively may be removable or releasable in nature. Similarly, coupled can refer to a two member or elements being in communicatively coupled, wherein the two elements may be electronically, through various means, such as a metallic wire, wireless network, optical fiber, or other medium and methods.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

The present disclosure relates generally to a door opening apparatus and system regarding the same that can include a motorized wheel that is spring-loaded with a linear actuator. This design ensures consistent traction force on any ground surface, allowing the system to pull or push doors open with the required force. The spring-loaded mechanism adjusts dynamically to maintain optimal contact between the wheel and the floor, ensuring reliable operation regardless of small variations in floor level.

The door opening apparatus of the present invention can be configured implement an algorithm to calculate the required motor speed, torque, and power and spring constant to achieve sufficient traction and generate enough force to open a door. The device can generally include a motor 104, biasing means 102, linear actuator 103, wheel 105, current sensor 310, IMU 330, and controller 400. In some exemplary embodiments, a system 1 of the present disclosure can further include other sensors, components, and subsystems.

Unlike conventional overhead automatic door openers that mount to the top of a door frame using motorized linkage mechanisms and require high-torque motors, extensive structural reinforcement, and professional electrical wiring into building AC infrastructure, the door opening apparatus of the present disclosure utilizes a motorized wheel positioned at or below the door handle and proximate to the floor 2000 for maximum mechanical advantage. The present invention is further distinguished from prior wheel-based door opening devices, by virtue of its spring-loaded wheel mechanism in which a biasing means 102 can be actively pre-tensioned by a linear actuator 103 to dynamically maintain consistent and adjustable traction force on any ground surface. Prior art devices cannot dynamically and precisely adjust the normal force and resulting friction between the wheel and the floor in real time.

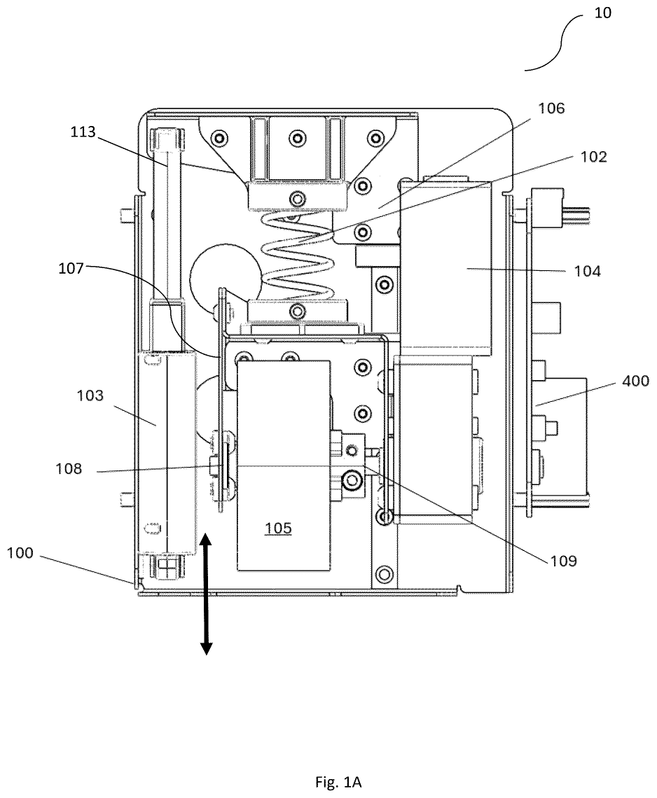

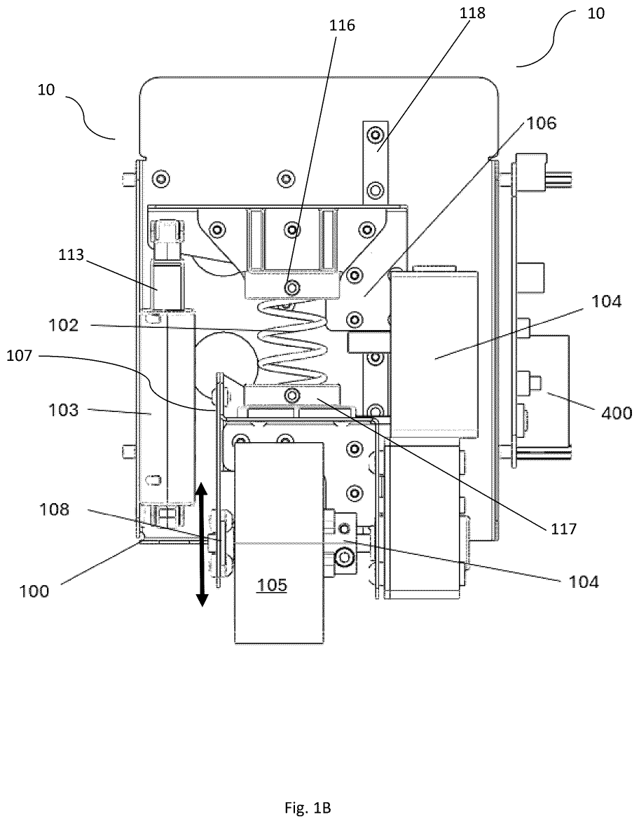

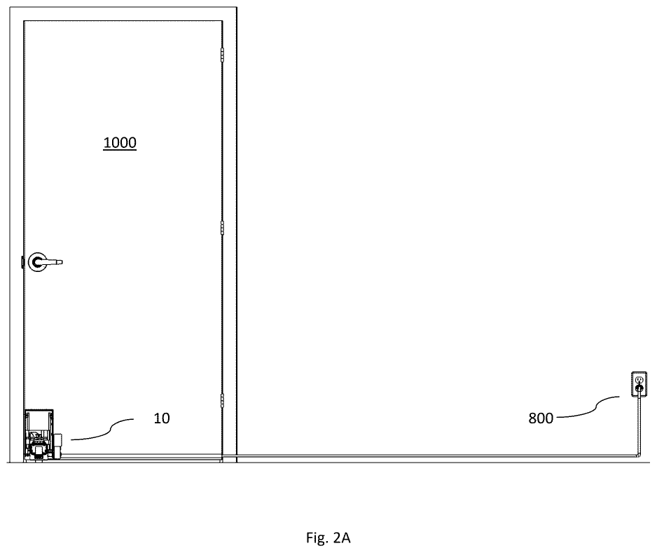

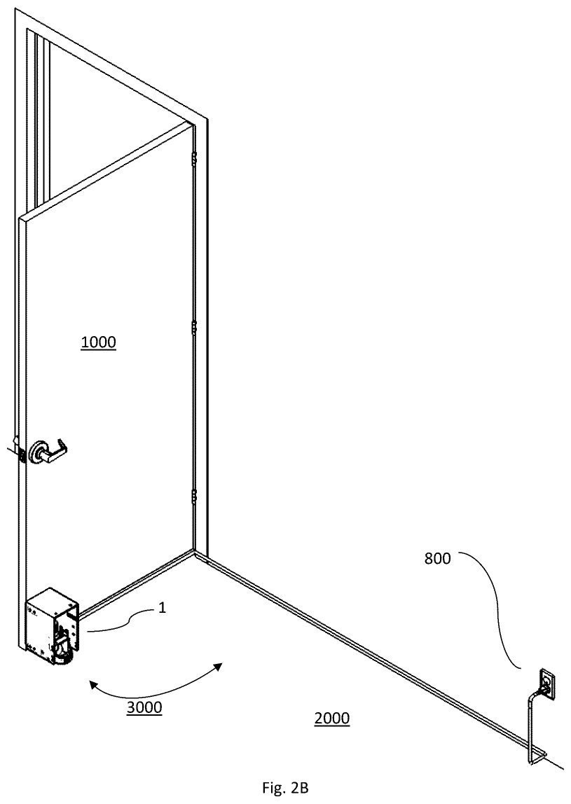

As shown in FIGS. 1-10, a door opening apparatus or system 1 of the present disclosure can include a housing member 100 that can contain the various components of the door opening apparatus 1. The housing 100 can include a base plate 101 that can be attached securely to the door 1000. The motorized wheel assembly can include a spring-loaded with a linear actuator 103 to maintain contact with any ground surface or floor 2000 so the wheel 105 can provide consistent traction force on the floor to pull or push a door 1000 open or closed with the required force. The force sufficient for the door opening apparatus 10 to pull or push a door 1000 open or closed independently and without any external physical force necessary to be applied onto the door. The biasing means 102 can be any suitable means, including but not limited to a spring, bar spring, helical compression spring, disc springs, shape memory alloy springs, van actuator springs, pre-stressed/constant force springs. In some exemplary embodiments, a biasing mechanism 110 can include a housing that can support a first end of the biasing means. The housing 111 can similarly be coupled to at least one end of a linear actuator 104. A drive motor or servo motor 104 can be utilized to rotate the wheel 105 along a first axis in order to move the door 1000 from a first position to a second position. A wheel motor coupler 109 can be used in some exemplary embodiments to couple the wheel assembly to the wheel motor 104. Similarly, a motor apparatus or assembly 104 can be utilized to drive the wheel 105. In some exemplary embodiments the actuators and motors utilized can optionally include motor drivers that can provide an interface between the controller 400 and the motor or actuator. A motor driver 410a,b can be used help translate control signals into precise voltage and currents needed to manage speed, direction, position, and torque. The motor drivers can be any suitable design including an electronic power amplifier.

In some exemplary embodiments, a spring-loaded linear actuator tensioning mechanism can pre-tension the spring 102 using a linear actuator 103 to ensure that relatively consistent force is applied to the spring 102 that reduces the likelihood that the wheel 105 will slip on different surfaces 2000. The spring 102 can also act as a suspension to handle surface transitions with different heights or divots in the floor 2000. The wheel 105 itself can be made from a compliant rubber or rubber-like material that has a gummy-like flexibility that is part of the effective spring 102 suspension effect and provides a high coefficient of friction with typical floor surfaces 2000. The wheel 105 material can be selected so that it does not mark most surfaces 2000. The linear actuator 103 can include a motor driver 104.

A linear actuator 103 can be coupled to a portion of the housing 100. An arm 113 of the linear actuator 103 can be coupled to a support or drive motor assembly 106 that allows for the linear motor 103 to extend and provide a range of motion of the wheel assembly 107 along a vertical axis as shown in FIGS. 1A-B. The biasing means 102 can be positioned between the support assembly 106 and wheel assembly 107. The wheel assembly 107 can have a support or mounting portion 117 for a first end of a biasing means 102 and the support assembly 106 can have a mounting or support portion 116 for a second end of the biasing means 102. The support assembly 106 and wheel assembly can be coupled together at one or more points.

The controller 400 can include a microcontroller or logic circuit. The controller 400 can be communicatively coupled to various elements of the system including the linear actuator, drive motor 104, transceiver, one or more sensors, and other components. The transceiver can be separate or incorporated into the controller 400. A controller 400 can process sensor data and controls motor operation, ensuring smooth and accurate movement of the wheel and pressure of the wheel 105 against a floor surface in order to maintain an adequate amount of friction to open the door. In some alternative embodiments, a simpler electronic logic circuit could be used in place of a microcontroller.

A wheel assembly 107 can include a housing 200 that interfaces with the linear actuator 103, biasing means 102, and drive motor 104 for the wheel. The wheel 105 can be positioned within the housing 200 and can be moved between a first position and a second along a generally vertical axis. The movement along the vertical axis can affect the force exerted by the wheel 105 on the ground 2000 and can thereby affect the friction between the wheel and the ground. When the drive actuator 104 is activated, the wheel 105 can spin, allowing the apparatus 10 to move along a path 3000. The path can be determined by the type of application and one or more sensors 300. In hinged applications, the path can generally be an arched shape, whereas for sliding door configurations, the path can be more substantially linear. The wheel assembly 107 for the wheel can be coupled to move along a vertical axis when the linear actuator 103 moves the wheel 105 from a first position to a second position as shown in FIGS. 1A-1B. A guide or support member 1118 can be included on a portion of the housing to further aid in guiding the wheel and support assemblies along the vertical axis.

In some exemplary embodiments, the door opening apparatus 10 can be configured for use with sliding doors, barn doors, or pocket doors by rotating the wheel assembly 107 or apparatus 1 entirely approximately 90 degrees relative to its orientation for a hinged swinging door. In the hinged door configuration, the wheel 105 rotates in a plane that is generally perpendicular to the plane of the door 1000, and the wheel's contact path 3000 along the ground surface 2000 follows an arc corresponding to the door's rotational swing about its hinge axis.

In the sliding door configuration, the wheel 105 is oriented so that its axis of rotation is generally perpendicular to the door's plane, and the wheel's contact path follows a substantially linear trajectory along the ground surface 2000 corresponding to the door's lateral sliding motion. The spring-loaded linear actuator mechanism operates identically in the sliding door configuration: the linear actuator 103 pre-tensions the biasing means 102 to press the wheel 105 against the ground surface 2000, and the drive motor 104 rotates the wheel 105 to translate the door 1000 laterally along its track or guide rail. The controller 400 can be configured with a selectable operating mode that adjusts the control parameters for sliding door operation, including different target forces, speed profiles, and angular position limits appropriate for linear rather than rotational door motion. In the sliding door mode, the IMU 330 or an alternative linear position sensor can track the door's lateral displacement rather than angular displacement.

The controller 400 can utilize data from various sensors 300 to determine the amount of force necessary to maintain appropriate force between the wheel 105 and the ground surface 2000. The controller 400 can further include a memory 401 and/or be communicatively coupled to a microprocessor 402 and/or database 403 to carry out one or more calculations given the acquired sensor data 301 that can include environmental data, such as coefficient of friction, torque, wheel radius, spring stiffness, and spring deflection, which can then be used to exert a required force when opening a door 2000. Furthermore, the memory 401 and microprocessor 402 can store one or more pre-set configurations that can be manually altered, or new configurations established, depending upon the desired positions by a user. Similarly, at least two pre-set configurations can be included wherein the door 2000 is positioned in a first position and a second position. One or more other pre-set configurations can be added depending upon desired user requirements, including the duration of the door staying in one or more of the pre-set positions after being actuated.

The algorithm developed and implemented by the system allows for the design space of the door opener apparatus 10 to be configured for opening doors of any size with typical opening forces using a conventional motor, spring, wheel, and linear actuator.

The controller 400 can execute one or more operations and communications to the system. In one exemplary embodiment, the door opener system 1 can include a timed opening mode 404 where the door stays open for an adjustable amount of time. This feature is particularly useful in high-traffic areas such as office buildings or public facilities. Users can set the duration based on their specific needs, from short intervals to longer periods.

In some exemplary embodiments, the apparatus and system of the present disclosure can utilize one or more programs such as a toggle mode and/or non-interference design. In a toggle mode, the door opener keeps the door open until it receives a signal to close. This ensures that the door remains accessible while minimizing unnecessary opening and closing cycles. When the system 1 is not in use or triggered to release tension, the controller 400 can trigger the actuator 103 to disengaged or move the drive wheel 105 to lift off the ground 2000, ensuring zero resistance to normal manual operation of the door 1000. The controller 400 can be communicatively coupled to a button 500 or a separate mobile device 600 that can be utilized to control the door 1000. In some exemplary embodiments, the system can include a transceiver 405 that can communicate with other devices 700 through a wireless network. This can allow a user to control the apparatus remotely with a smart phone or other wireless device or controller 700.

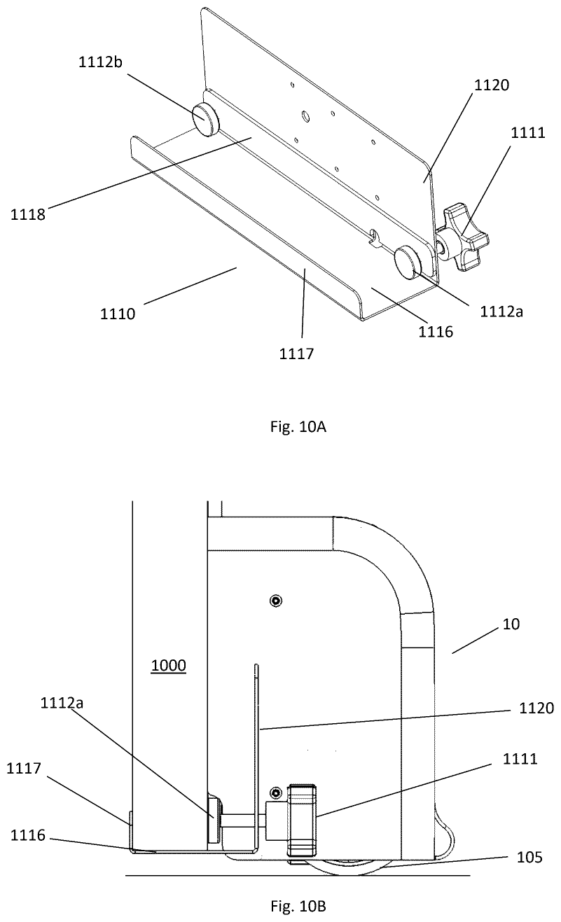

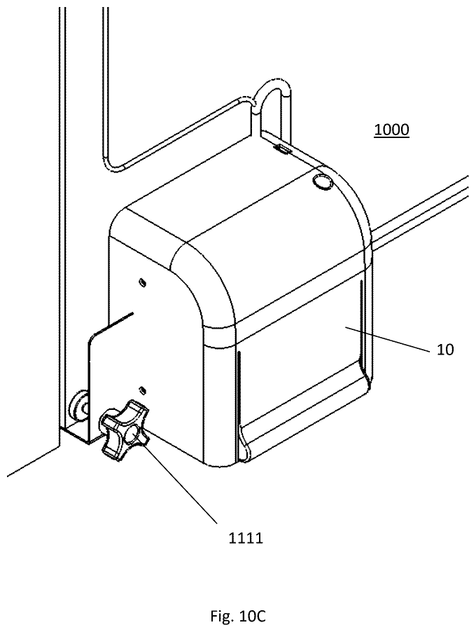

The apparatus 10 of the present disclosure can be mounted onto preexisting doors 1000, including but not limited to hinged and sliding doors, and can be coupled anywhere desired onto the door. In some exemplary embodiments, the apparatus is coupled below the door handle for maximum mechanical advantage when actuated to open the door. The apparatus 10 can be coupled in various ways. In one embodiment, the apparatus 10 can be fastened onto or into a door 1000 for permanent installations. Second, it could be clamped against the door for a quick and secure attachment without drilling holes as shown in FIGS. 10A-C. It could also be taped or attached using hook and loop fasteners or magnets to the door for a more temporary solution that can be easily removed.

A door opening system 1 that utilizes the apparatus 10 can include one or more sensors for safety during opening and closing. The sensors can be sensing or proximity sensors to determine if a person or object is in the path of the door. A limit switch can detect external context, such as the wall or obstacles near the door. These switches provide additional safety by stopping the door from moving if it encounters an unexpected obstacle. Current sensors can be used to detect the current delivered to the drive motor and linear actuator motors. These sensors detect the current draw, which could be used to control the torque of the drive motor and linear force of the linear actuator. These sensors could also indicate whether an obstruction or mechanical issue is present. When such a condition is detected, the system can automatically stop movement to prevent damage and may include a short reverse motion to relieve pressure on any obstructing objects. The motor and gearbox in this apparatus require less torque due to a higher mechanical advantage, which also helps in minimizing strain and extending the device's operational life. The system can include one or more indicators that can include visual indicators and audible indicators, such as LED lights or a buzzer/alarm, respectively.

In some exemplary embodiments, the drive motor 104 is a highly backdriveable motor, such as a brushless DC motor, that permits the door 1000 to be manually pushed or pulled by a user even while the wheel 105 is in engaged contact with the ground surface 2000. This high backdriveability allows the motor 104 to respond dynamically to external forces applied to the door 1000 by a user, as detected by the IMU 330 or door angle sensor. The combination of high backdriveability and selective motor braking enables the apparatus to serve simultaneously as a door opener, a door closer, and a door position hold device, without requiring a separate overhead door closer or mechanical latch, while allowing the user to manually override the system at any time by simply pushing or pulling the door 1000.

One or more encoders or wheel rotary position sensor(s) 370 can be communicatively coupled to the controller 400. The encoders can be used on the wheel to accurately track its rotary position and speed. This data can be used for precise control of the door movement to ensure smooth and consistent operation.

A linear potentiometer or linear variable differential transformer (“LVDT”) can be integrated with the linear actuator 103 to monitor its extension and retraction position in real time. This sensor can provide continuous real-time feedback to the controller 400 regarding the precise displacement of the biasing means 102 and/or linear actuator's position 103, allowing, allowing for fine-tuned control over the spring force exerted onto the wheel 105 against the floor surface which can dictate the amount of wheel traction force to open the door 1000. This real-time positional feedback enables the system to prevent excessive door opening force is prevented by precisely controlling the spring displacement, reducing wear on system components, and permits a user to manually override the door opener by pushing or pulling the door even while the mechanism is engaged. The manual override of the system can prevent the door from hitting people or objects with high force. In some exemplary embodiments, a manual button can be coupled to the actuator to deactivate the actuator or spring tension when desired or in case of power outages.

An Inertial Measurement Unit (“IMU”) or a dedicated door angle sensor 330 can be used to detect the door's current angle and its speed of rotation. This information can aid in the CPU or controller 400 to control opening and closing speeds of the door, as well as detecting any obstructions that may impede its movement. An IMU 330 may also detect door angle when the drive system is disengaged and the door is manually operated to a partially open position; as the system is reengaged by user input, the IMU or angle sensor 330 provides door position information to the controller 400 relative to targeted fully-open or fully-closed positions.

An IMU 330 or dedicated door angle sensor integrated into the apparatus 10 of the system 1 of the present disclosure can provide a comprehensive real-time control of the door's angular position and angular velocity, enabling multiple intelligent control modes. In operation, the IMU 330 can continuously monitor a door's angle relative to its closed position and its rotational velocity. When the apparatus is actively opening or closing the door and the IMU can detect that a user or an object has stopped or impeded the door's motion. In one example, the IMU 330 can detect a sudden deceleration or deviation from an expected angular speed profile or predetermined threshold to alert the controller 400 to immediately stop the drive wheel motor 104 to prevent the door from applying force against the person or obstacle.

The system can further utilize various modules and programs for opening and closing the door. In some exemplary embodiments, if the IMU 330 subsequently detects that the user is pushing on the door in an opening direction, the controller can drive the wheel motor to assist the user in opening the door to a maximum angle limit determined by the IMU or thresholds set by a user and saved in the memory. Conversely, if the IMU 330 detects that the user is pushing the door in a closing direction, the controller drives the wheel motor to assist in closing the door to the fully closed position. The IMU can also detect if the door is attempting to close on a user or object—such as when a door closer is applying force—at which point the controller 400 can stop or deactivate the drive wheel motor 104 and releases pressure on the system to prevent injury or entrapment. This IMU-based control system 330 can enable total control of the door's angle and angular velocity, which can be used both for safety features (preventing the door from pushing on a user or object) and for intuitive push/pull assistive opening and closing control that allows a user to interact naturally with the door while the apparatus provides powered assistance.

The various sensors can be communicatively coupled to the microprocessor that can then be used or stored data and new data to optimize the system. In some exemplary embodiments, the motor 104 can be controlled using an adjustable timer that can have predetermined intervals, including but not limited to a maximum time to move the wheels. This timer could be adjustable in the algorithm or memory via the controller 400, by the user using a potentiometer, buttons, or dip switches, or keep track of the history of typical door opening/closing times and calibrate itself. Motor current sensors can detect the amount of current provided to the motor by the motor driver, and the controller 400 will use this real-time current info to ensure that the motor is not overloaded or stalled in the case of the door or device hitting the wall or an obstacle that impedes the door opening. Since motor current is typically proportional to torque (such as in a DC motor), sensing current is an excellent method to detect motor overload or stall conditions. The motor could also have a wheel encoder that connects to the controller 400 to track the motion and distances traveled of the wheel, though this may not give complete information because the wheel could slip and give incorrect readings. This wheel encoder could enable the door to be opened and closed fully or part of the way. An IMU 330 can be added into the system to measure the door angle relative to its closed position during operation. The IMU 330 could be used to detect whether the door is achieving the desired door opening angular speed profile to control the mechanism speed and detect if obstacles were encountered along the way. The limit switches 340 can detect when contact with the device has occurred, such as when the door is fully open and hits a wall/obstacle or closes and hits the door frame.

The system can utilize any suitable power source including but not limited to wired power sources. Batteries may be ideal for installations where electrical wiring is not feasible, and a battery backup 801 can be provided for situations where power may be interrupted from a direct powered system. A wall plug can provide continuous power for reliable operation, and for permanent installations, it can be wired directly into the existing building electrical infrastructure. Additionally, the system may incorporate a charging mechanism for battery-powered configurations, enabling temporary connection to wall power when the door reaches a fully open or closed position. This charging interface can be achieved through a physical connection, such as metallic contact pads that engage when the door reaches its designated position, or through wireless charging pads that align when in proximity. These power options can be implemented using wire conduit for safe and clean routing in retrofit installations or as fully embedded power connections in a “Smart Door” replacement solution. In either the wired contact pad or wireless charging embodiment, the controller 400 can monitor the battery charge level and provide notifications to a user via the mobile device 600 application or an indicator LED on the housing 100 when the battery is low or charging, and can enter a low-power sleep mode between activation signals to conserve battery life.

The system can additionally be communicatively coupled to a latching device or mechanism. In some exemplary embodiments, the door opening system 1 can include a latch kit that blocks an existing spring-loaded door latch from springing forward. This ensures the door remains securely closed while providing some resistance to prevent unintentional opening. Additionally, a small magnetic latch using a magnet and steel plate can be used as an alternative latching mechanism. Additionally, the system can integrate with electronic deadbolts and/or latches via wired or wireless communication for comprehensive access control including various modalities or modules 450. These modalities 450 can include a wired switch, wireless switch, voice control module, home assistant integration, motion sensor, touch sensor, software application, and access control systems to allow a user various means to provide access control of the system. This allows users to manage door locks alongside the automated opening and closing functions, providing enhanced security features.

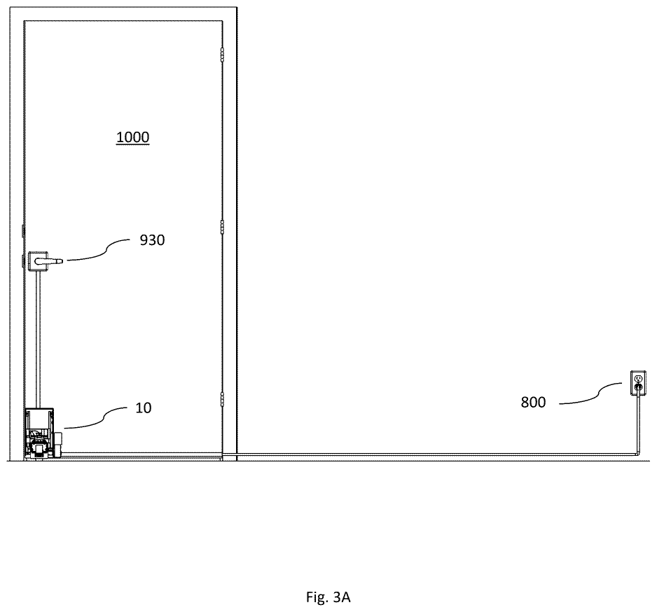

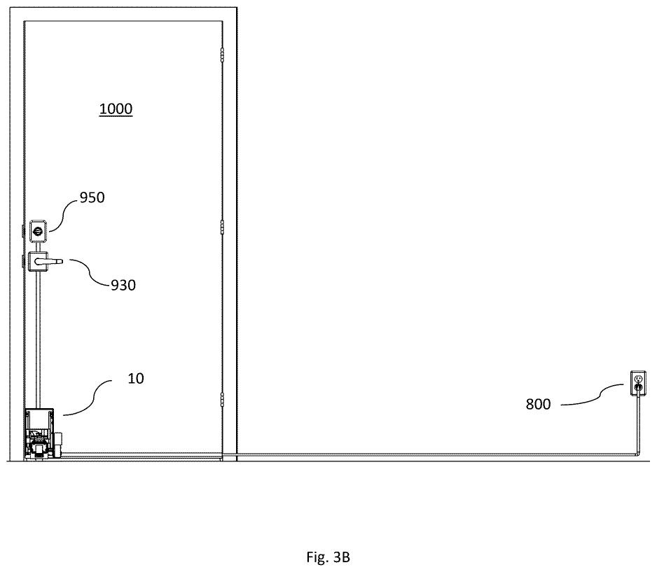

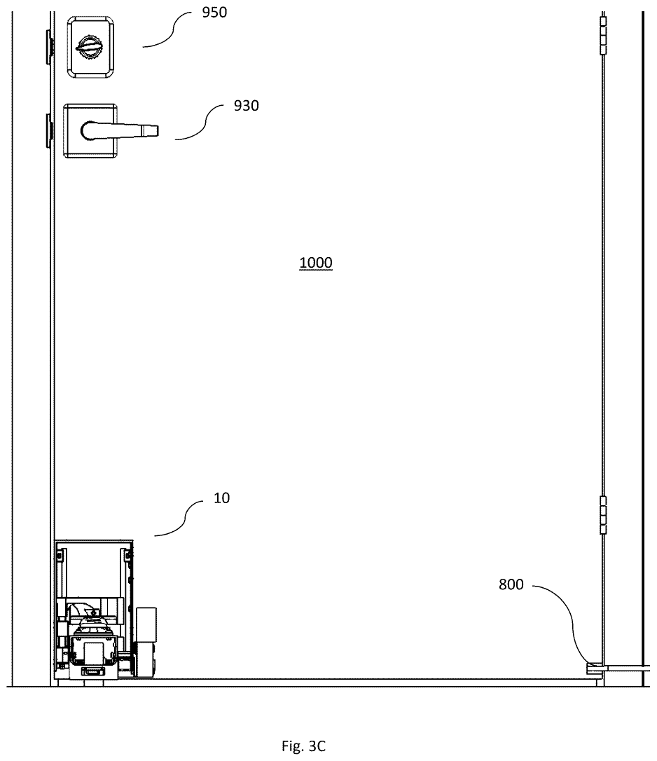

As shown in FIGS. 3A-C, the apparatus 10 acts as a central power and/or processing hub, directly wiring to, and powering the electronic deadbolts and/or latches subsystems 900), thereby eliminating the need for independent battery replacement in those peripheral devices. The wiring can be done via internal or exterior door wiring routed directly from the door opening apparatus. FIGS. 3A-3B provide illustration of exterior ran power connections between each of the apparatus and subsystems, while FIG. 3C provides an internally routed power connection. The apparatus 10 provides continuous power from a standard wall outlet to all connected peripherals and includes an internal backup battery that serves the entire system in the event of power failure, eliminating the need to monitor and replace separate batteries in electronic deadbolts or other locking mechanisms. The apparatus 10 creates a modular system that can be powered by a standard wall outlet and can have one internal battery backup in the apparatus 10 in case of power failure. The system 1 can further be powered by other power sources or power supply unit 800, such as a one or more battery elements.

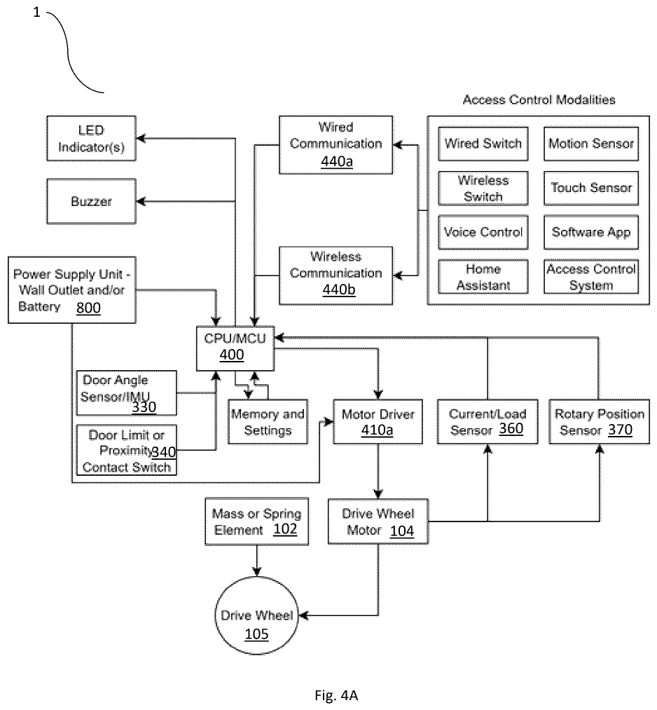

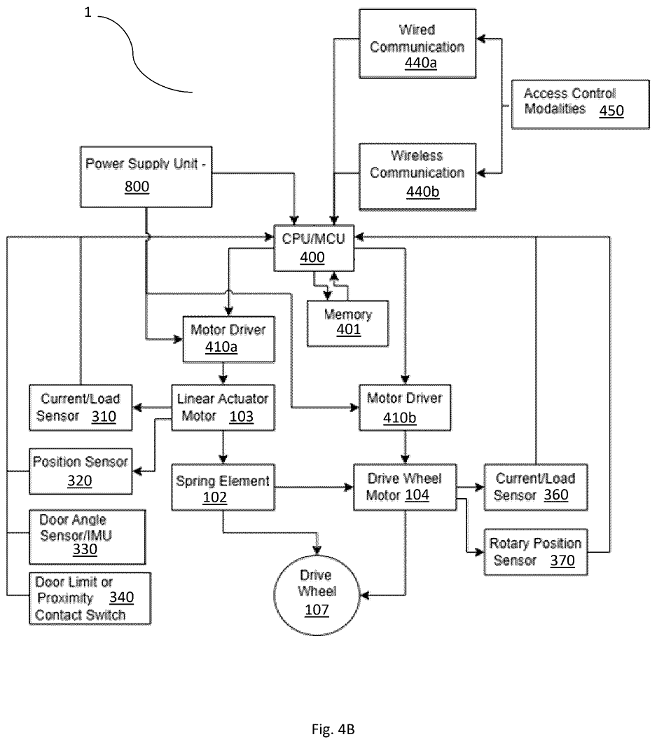

Referring now to FIG. 4A, a system diagram of an exemplary embodiment of the door opening apparatus 10 of the present disclosure is shown. The door opening apparatus 10 can generally include a housing 100 configured to be coupled to a door 1000, a drive motor 104 configured to rotate a wheel 105 around an axis, and a controller 400. In some exemplary embodiments, the housing 100 can at least partially house the primary components including, the wheel, actuator, motor, and controller. The controller 400 can comprise a microcontroller or logic circuit communicatively coupled to the drive motor 104. In operation, the controller 400 receives an signals from various components such as access control modalities, sensors, motors, a mobile device 600, or another wireless devices 700, and subsystems. The controller 400 in response commands the drive motor 104 to rotate the wheel 105, thereby moving the door 1000 from a first position (e.g., closed) to a second position (e.g., open), or vice versa. When the system 1 is not in use, the wheel 105 can be positioned in a retracted position spaced from the ground surface 2000 so that the apparatus provides zero resistance to normal manual operation of the door 1000. Alternatively, the wheel can be locked and maintained in the final position to maintain the door in a closed position.

The basic system diagram of FIG. 4A illustrates a fundamental architecture of the door opening system 1 without the addition of the spring-loaded linear actuator mechanism and sensor subsystems described in greater detail below. A passive biasing element 102 to engage the wheel 105 with the ground surface 2000. In this simplified embodiment, the wheel 105 is biased toward the ground surface 2000 by a spring element, a mass element, or a combination thereof, without active control over the downward force. The weight of the wheel assembly 107 and the passive biasing element provides a substantially constant normal force between the wheel 105 and the ground surface 2000.

The simplified embodiment trades the dynamic force adjustment capability of the linear actuator-based system for reduced mechanical complexity, lower cost, and a smaller form factor, while retaining the IMU-based push/pull assistive control, the sensor-based safety features, and the communication and IoT capabilities of the full system. The simplified system is particularly well suited for interior doors with lower opening force requirements and consistent floor surfaces, where the passive spring or mass element provides sufficient and reliable traction force without active adjustment.

The wheel 105 can be locked by one or more mechanisms including: (a) the drive motor 104 applying a holding torque or electrically braking the wheel 105 to resist rotation; (b) a mechanical locking mechanism, such as a pin, pawl, or friction brake, that engages the wheel 105 or its shaft to prevent rotation; or (c) the linear actuator 103 increasing the downward force on the biasing means 102 to press the wheel 105 against the ground surface 2000 with sufficient force that the static friction between the wheel 105 and the ground surface 2000 resists movement of the door 1000. When the wheel 105 is locked in the engaged position, the apparatus 10 effectively replaces the function of a traditional spring-loaded door latch or door closer by preventing the door 1000 from being opened by wind, vibration, or incidental contact, while still permitting intentional opening when the controller 400 releases the wheel lock in response to an activation signal or a detected user push via the IMU 330. The controller 400 can be configured to apply different levels of holding force depending on the operating context. For example, a lower holding force can be applied for interior doors where only wind or vibration resistance is needed, and a higher holding force can be applied for exterior doors or security-sensitive applications where greater resistance to unintentional opening is desired.

As shown, the system 1 includes a power source 800, which can include but is not limited to batteries, a wall plug, or a wired connection to building power. The power source 800 provides electrical power to the controller 400, which can be communicatively coupled to a memory 401. The controller 400 is communicatively coupled to a linear actuator 103 and a drive motor 104 through respective motor drivers 410a, 410b. The motor drivers 410a, 410b can translate control signals from the controller 400 into precise voltages and currents needed to manage speed, direction, position, and torque of the linear actuator 103 and drive motor 104, respectively.

A linear actuator 103 is configured to move a wheel assembly 107 between a first position (retracted, spaced from the ground surface 2000) and a second position (engaged, in contact with the ground surface 2000) by actively pre-tensioning a biasing means 102. The drive motor 104 is configured to rotate the wheel 105 of the wheel assembly 107 around an axis to move the door 1000 between an open position and a closed position.

A system 1 as shown in FIG. 4B can further include a plurality of sensors communicatively coupled to the controller 400. A current sensor 310 is configured to detect the electrical current delivered to the drive motor 104 and/or the linear actuator 103. The current sensor 310 enables the controller 400 to monitor motor torque in real time, detect motor overload or stall conditions indicative of an obstruction or mechanical issue, and control the linear actuator force by correlating measured current to a known force-current relationship. A linear potentiometer or linear variable differential transformer (“LVDT”) 320 is integrated with the linear actuator 103 to monitor its extension and retraction position in real time, providing continuous feedback to the controller 400 regarding the precise displacement of the biasing means 102 and allowing for fine-tuned control over the spring force exerted onto the wheel 105. One or more wheel rotary position encoders 370 are communicatively coupled to the controller 400 and configured to track the rotary position and speed of the wheel 105, enabling precise control of the door movement. A limit switch 360 is configured to detect external context, such as contact with a wall or obstacles near the door 1000, providing additional safety by stopping the door from moving if it encounters an unexpected obstacle.

The controller 400 can be further communicatively coupled to one or more communication interfaces 440a, 440b. The communication interfaces can include wired communication protocols 440a and wireless communication protocols 440b, which can include but are not limited to RF, Wi-Fi, Bluetooth, Zigbee, and an IoT interface, including voice control. These communication interfaces 450 enable the controller 400 to receive activation signals from, and transmit status information to, external devices including a button 500, a mobile device 600, and other wireless devices or controllers 700.

Referring now to FIG. 4C, a system diagram of an exemplary embodiment of the door opening system 1 of the present disclosure is shown including additional components and subsystems 900. The door opening apparatus 10 can serve as a central power and processing hub for one or more peripheral modules/subsystems 900, which can include a dedicated unlatching unit (such as a latch actuator configured to actuate a door latch mechanism), a handle-based unlatching mechanism (configured to actuate a door handle or lever to retract a spring latch), and/or a wired electronic deadbolt. A wiring path can be routed along or through the door 1000 from the door opening apparatus 10 to each peripheral module, enabling the apparatus 10 to distribute continuous electrical power from the power source 800 to the peripheral modules and to send control signals coordinating latching and unlatching operations with door opening and closing sequences. The controller 400 can further establish bidirectional communication with each peripheral module through the wiring path, enabling the peripherals to report status information, including locked or unlocked state, latch engagement confirmation, battery backup status, and fault conditions, back to the controller 400. This modular system architecture, in which the door opening apparatus 10 acts as the central hub of the system 1 for delivering both power and control signals to interchangeable peripheral door hardware through standardized wiring paths, enables end users to configure a customized door automation solution by selecting and combining peripheral modules suited to their specific door hardware.

FIG. 4C further illustrates the controller 400 communicatively coupled to a memory or a database. The microprocessor 402 and memory 401 can store one or more pre-set configurations that can be manually altered, or new configurations established, depending upon user requirements, including the duration of the door staying in one or more pre-set positions after being actuated. The controller 400 can execute one or more operational modes, including a timed opening mode where the door stays open for an adjustable amount of time, and a toggle mode where the door opener keeps the door open until it receives a signal to close. A transceiver can communicate with other devices through a wireless network, allowing a user to control the apparatus remotely.

In some embodiments, the door opening system 1 of the present disclosure dynamically adjusts the spring downforce on the wheel during operation to maintain optimal traction force. This dynamic adjustment can be implemented by the controller periodically commanding the linear actuator to push downward against the biasing means and measuring the electrical current drawn by the linear actuator 103 during this action. In some exemplary embodiments where the force exerted by the linear actuator 103 is proportional to its current draw, the controller 400 can determine the current spring force (F=k·x) by correlating the measured current to a known force-current relationship. The controller 400 can then adjust the linear actuator's position to achieve a target current value corresponding to a desired spring force. This current-based feedback loop enables the system to compensate for changes in floor height, surface transitions, thermal expansion, and wear over time without requiring an external force sensor. In a further embodiment, an optional load cell force sensor can be positioned at the top or bottom of the biasing means to provide direct, continuous measurement of the spring force in real time. A load cell can provide a more precise force measurement than current sensing alone, and the controller can use the load cell data in a closed-loop feedback system to command the linear actuator 103 to adjust the biasing mechanism deflection and maintain the desired spring force with high accuracy. In some exemplary embodiments, spring deflection energy can be used to absorb bumps and slopes in the floor surface.

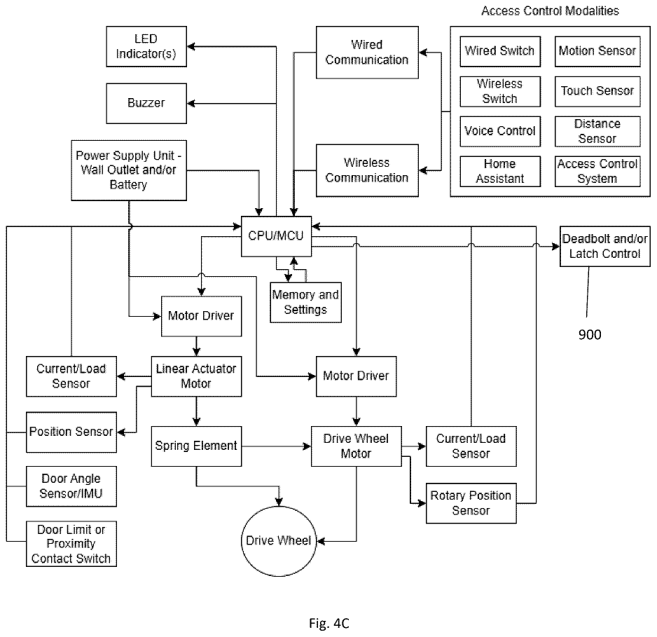

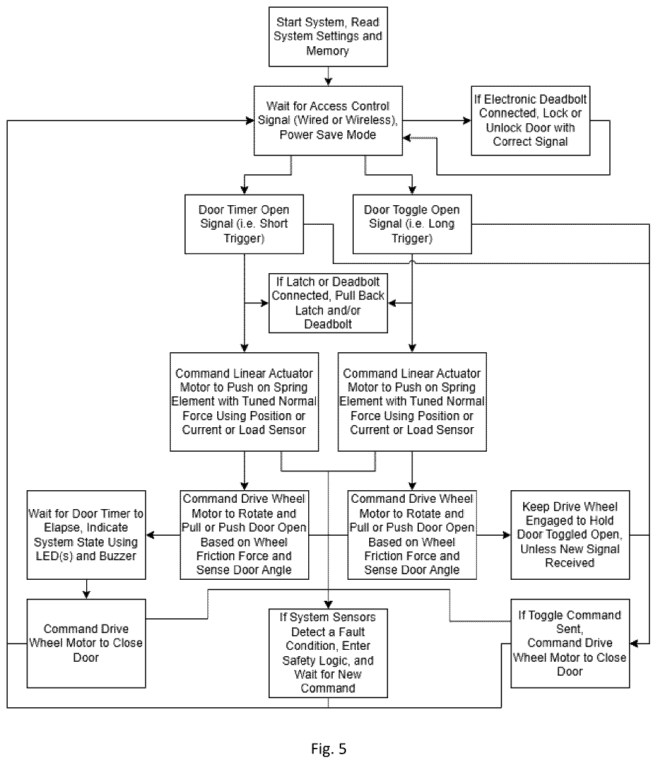

Referring now to FIG. 5, an illustration of a method of operation of an exemplary embodiment of the door opening apparatus 1 of the present disclosure is shown. The method begins when the controller 400 receives an activation signal from a user input device, which can include a physical button mounted proximate to the door, a mobile device running a dedicated application, a wireless remote control device, a voice command received through an IoT interface, or any other suitable access control input including key fobs, motion sensors, RFID tags, and keypads.

Upon receiving the activation signal, the controller 400 first determines whether a latching peripheral is present and, if so, sends a control signal through the wiring path to command the latching peripheral to disengage the door latch or deadbolt. The controller 400 can verify that the latch has been disengaged, such as by receiving a confirmation signal from the latching peripheral through bidirectional communication, before proceeding to the next step.

The controller can command the linear actuator via the motor driver to extend from a first position to a second position, thereby moving the wheel assembly downward and pre-tensioning the biasing means to bring the wheel into engaged contact with the ground surface 2000. The linear potentiometer or LVDT can provide real-time feedback to the controller 400 regarding the linear actuator's position, and the controller 400 uses the physics-based algorithm stored in the memory 401 to calculate the required spring deflection, calibrating the biasing means deflection such that the wheel will slip on the ground surface if the applied force exceeds a target door opening force.

Once the wheel is engaged with the ground surface at the calculated spring deflection, the controller can instruct or command the drive motor 104 to rotate the wheel in a first rotational direction to move the door from a closed position toward an open position. During this operation, the controller can continuously monitor sensor data from the various sensors including but not limited to a current sensor, an IMU, a wheel encoder, and a limit switch. If the current sensor detects a motor current exceeding a predetermined threshold, or the IMU 30 detects a sudden deceleration or deviation from an expected angular speed profile, or the limit switch detects contact with a wall or obstacle, the controller immediately stops or reverses the drive motor and may retract the wheel to relieve pressure, thereby preventing the door from applying excessive force against a person or obstacle.

When the IMU or door angle sensor detects that the door has reached a target open angle the controller stops the drive motor. The target open angle can be a pre-set value stored in the memory or a maximum angle limit determined by a limit switch 340 detecting contact with a wall. In a timed opening mode, the controller maintains the door in the open position for an adjustable or predetermined amount of time before commanding the drive motor 104 to rotate the wheel in a second, opposite rotational direction to close the door. A motion sensor or presence sensor can similarly be communicatively coupled to prevent the door from closing if there is still a detected presence. The motion sensor or presence sensor can be any suitable type including, but not limited to, a passive infrared (PIR) sensor, an ultrasonic proximity sensor 340, a time-of-flight (ToF) sensor, a LIDAR sensor, or a camera-based presence detection system. In a toggle mode, the controller maintains the door in the open position until a close signal is received from a user input device.

The motion sensor or presence sensor can be mounted on the housing 100 of the apparatus 1, on the door 1000 itself, on the door frame, or on an adjacent wall surface proximate to the doorway. When the controller 400 determines that the door 1000 should begin a closing operation, whether triggered by a timer expiration in the timed opening mode 404, a user command, or another signal, the controller 400 first queries the motion sensor or presence sensor to determine whether a person or object is detected in the doorway. If a presence is detected, the controller 400 delays the closing operation until the detected presence clears the doorway, thereby preventing the door 1000 from closing on a person or object.

During the closing operation, the controller again monitors sensor data for obstacle detection. If the IMU detects that a user or object has impeded the door's closing motion, the controller can stop the drive motor 104. In some exemplary embodiments, the linear actuator can be triggered to raise the wheel assembly removing all resistance.

Once the door 1000 has returned to the fully closed position as confirmed by the IMU, the controller can command the linear actuator 103 to retract the wheel assembly to the first position, lifting the wheel off the ground surface so that the apparatus provides zero resistance to subsequent normal manual operation of the door. If a latching peripheral or subsystem is present, the controller 400 can then send a control signal to command the deadbolt to engage and/or the latch to re-engage, and can verify successful engagement through bidirectional communication with the peripheral subsystem. The controller may then report system-wide status to the user via the mobile device application or other connected interface.

A door opening system 1 of the present disclosure can be configured as a modular system in which multiple types of latching and unlatching peripherals/subsystems 900 that can be interchangeably communicatively coupled to the apparatus 10 that can function as the central power distribution and processing hub via standardized wiring paths. These peripherals 900 can include, but are not limited to, a dedicated unlatching unit 910 configured to actuate a door latch mechanism, a handle-based unlatching mechanism 930 configured to actuate a door handle or lever, and a wired electronic deadbolt 950. Each peripheral module 900 can be designed to receive continuous electrical power and control signals from the door opening apparatus through internal or exterior door wiring from the apparatus 10, eliminating the need for independent batteries or separate power connections for each peripheral device. This modular architecture allows end users to configure a customized door automation solution by selecting and combining peripheral modules suited to their specific door hardware and security requirements, and further enables future expansion with additional peripheral types without modifying the core door opening apparatus.

The door opening system 1 of the present disclosure is further configured to send electrical power and one-way or two-way communication signals to connected latching peripherals, including the door latch system and electronic deadbolt, through the wiring paths routed along or through the door. In one embodiment, the door opening apparatus provides unidirectional control signals to the latching peripheral, commanding it to latch or unlatch in coordination with the door opening and closing sequence.

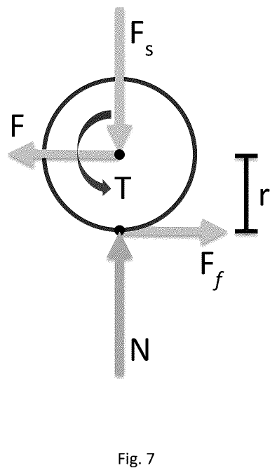

As shown in FIG. 8, bidirectional communication is established between the door opening apparatus and each peripheral, enabling the peripherals to report status information, including but not limited to a locked/unlocked state, latch engagement confirmation, battery backup status, or fault conditions, back to the controller of the door opening apparatus. This bidirectional communication enables the controller to verify that the latch has been disengaged before initiating a door opening operation, confirm that the deadbolt has been engaged after a door closing operation, and report system-wide status to a user via a mobile device application or other connected interface. The power and signal distribution can be achieved through a shared multi-conductor wiring harness or through separate power and signal conductors within the wiring path. This integrated power and signal distribution architecture, in which the wheel-based door opening apparatus serves as the central hub for delivering both power and control signals to peripheral door hardware, is not disclosed in any of the identified prior art references. FIG. 3C provides an illustration where the power source 800 is coupled to and integrated into the interior of the door and not seen on the exterior.

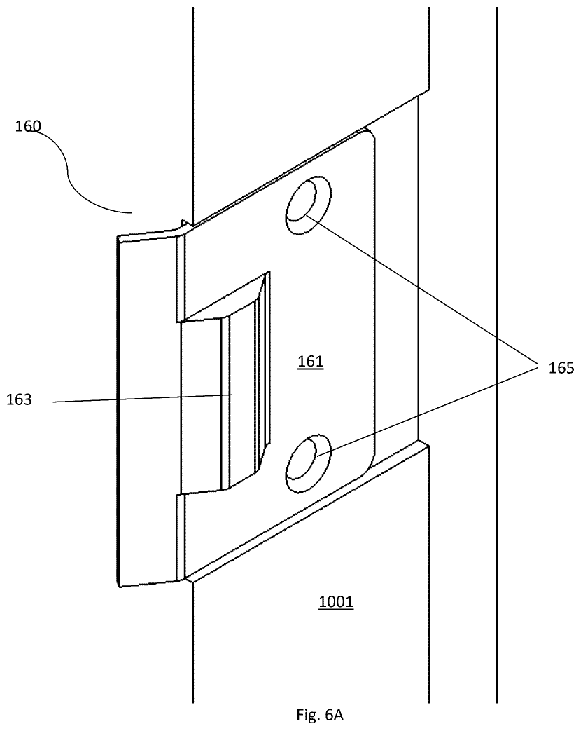

Typical door handle spring-latches can pose compatibility problems with the apparatus since they keep closed doors shut, so these spring-latches need to be replaced by a blocking latch plate 160, replaced with a more compatible latch like a cylinder/ball spring or magnetic latch, or the mating door frame latch plate should be replaced with a compatible plate option as shown in FIGS. 6A-6B. The latch plate 160 can include a body portion 161 that can be coupled to a door 1000 or door jamb 1100 to prevent a latch from engaging the aperture of the door jamb. A protrusion portion 163 can extend generally outward from the body portion 161 and can apply pressure against either the door or door jamb creating a prescribed amount of resistance between the door and door jamb. In some exemplary embodiments, the body portion 161 can further include one or more apertures 165 for mounting the latch plate 160. The latching mechanism can be removed entirely as the door opening apparatus can maintain the door in an open or closed position without the necessity of a latch. The linear actuator 103 can apply more pressure when in a locked position to provide a more secure positioning of the door, equating to a lock or latched position. Alternatively, an electronic deadbolt system 950 communicatively coupled could operate as a latch as well. In other exemplary embodiments, the door opening apparatus 10 could have a locking apparatus or mechanism that locks the wheel in a desired position preventing the door from being opened.

The automatic door motorized wheel system 1 can be compatible with existing locks in the doorknob or a deadbolt system because it must already have sensors that can detect when an overload or slipping condition is achieved by the device. If the door is locked and the device can't open the door, then it can just stop itself. A better option would be to include a custom fully integrated locking system or interfacing with an existing electronic deadbolt system that is electrically/wirelessly compatible with this device.

Various components of the door opening system and electronic locking system can be fully integrated into a “smart” door assembly. The entire door opener system, including an electronic deadbolt 950 and/or latch, can be integrated into a door with embedded wiring, creating a “Smart Door” solution that replaces existing doors seamlessly. This integration ensures a cohesive and modern aesthetic while offering advanced functionality.

The door opening apparatus 10 and system 1 of the present disclosure provides a more cost-effective solution and easier implemented system than conventional automatic doors. This provides greater accessibility to many users that would normally not be afforded the access to an automatic door system. Additionally, the apparatus 10 lifts off the ground when not in use for zero resistance to normal door opening. The apparatus 10 further provides a bi-directional control to both open and close, as well as maintain the door in the desired position for any desired period of time. The system can be compatible with wired or wireless communication) protocols 440a,b that can include but are not limited to RF, Wi-Fi, Bluetooth, Zigbee, with an IoT interface designed from the ground up, including voice control.

In some exemplary embodiments, the system 1 of the present disclosure utilizes a an algorithm that can be stored in a memory 401 can be implemented by the controller 400 to calculate and optimize system parameters and pressure application. In some exemplary embodiments, the algorithm can utilizes Hooke's Law (Fs=k·δx), where Fs is the spring force, k is the spring stiffness, and δx is the spring deflection controlled by the linear actuator, in conjunction with friction force equations (Ff=μ·N=μ·k·δx), to determine the precise motor torque (T=μ·k·δx·r) and door pulling force (F=μ·k·δx) necessary for a given door and surface combination. This analytical approach enables the apparatus to be configured for doors of any size and with typical opening forces using conventional components, and provides an inherent safety mechanism: the adjustable spring force can be calibrated so that the wheel will slip on the floor surface if the applied force exceeds the target door opening force, thereby preventing excessive force from being applied to persons or obstacles in the door's path. In these embodiment, a physics-based algorithm for dynamically calculating and adjusting motor speed, torque, spring constant, and spring deflection to maintain a no-slip condition while simultaneously capping the maximum applied force. Additionally, various thresholds can be established and saved to a memory to trigger a spring or safety release to remove all tension against the spring to allow for the door to move freely. This can prevent potential injuries if a user impacts the door or gets immobilized in the middle of an operation before clearing the doorway.

In some exemplary embodiments, the door opening system 1 of the present disclosure is configured to comply with applicable accessibility standards, including but not limited to the requirements of the Americans with Disabilities Act (ADA) and the ICC/ANSI A117.1 Accessible and Usable Buildings and Facilities standard. Under such standards, interior hinged doors are generally required to have a maximum opening force of 5 pounds-force (lbf), and exterior hinged doors are generally required to have a maximum opening force of not more than 10 lbf, though specific jurisdictions or building codes may impose different thresholds. The controller 400 can be configured with one or more pre-set ADA compliance modes stored in the memory 401 that automatically limit the maximum door opening force to a value at or below an applicable accessibility standard threshold. In an interior door mode, the controller 400 calculates the required spring deflection δx using the physics-based algorithm to achieve a maximum door pulling force F=μ·k·δx of no more than 5 lbf. In an exterior door mode, the controller 400 calculates the required spring deflection δx to achieve a maximum door pulling force of no more than 10 lbf. The controller 400 can automatically select the appropriate mode based on a user configuration stored in the memory 401, or the user can manually select the mode via the mobile device 600 application, a physical button 500, or another connected interface. Because the algorithm can inherently calibrates the biasing means 102 deflection so that the wheel 105 will slip on the ground surface 2000 if the applied force exceeds the target door opening force, the ADA compliance mode provides a built-in force ceiling that passively prevents the apparatus from exceeding the applicable accessibility standard threshold at any point during the door opening operation.

In some exemplary embodiments, the system 1 can generate and store ADA compliance reports in the memory 401 or transmit such reports to the mobile device 600 application or a building management system through the communication interfaces 440a, 440b. These reports can document the measured door opening force, closing speed, hold-open time, and other parameters for each activation cycle, providing facility managers with verifiable compliance data for inspection and audit purposes. The controller 400 can further generate alerts or notifications when the system detects that the measured door opening or closing forces are approaching or exceeding the applicable threshold, indicating that recalibration or maintenance may be required.

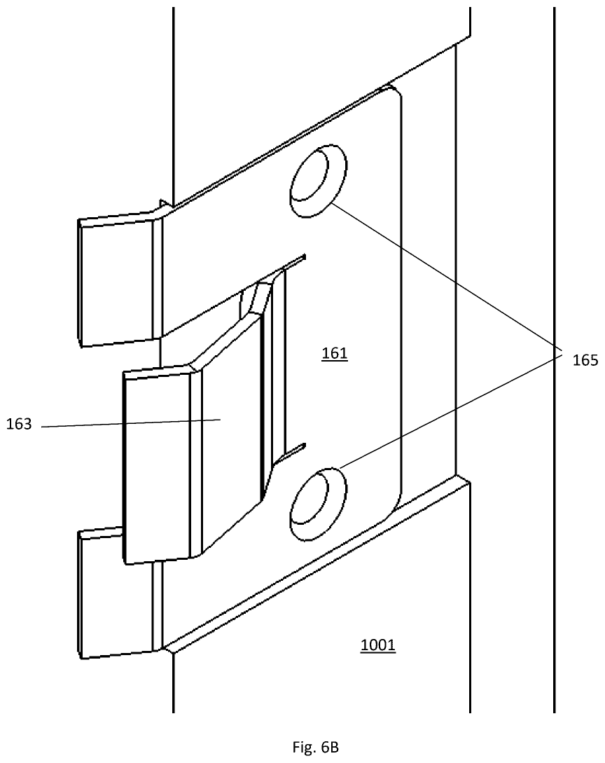

As shown in FIG. 7, free body diagram shows the forces acting on the motorized wheel using a physics-based model. The system 1 can utilize various data inputs from sensors or databases to provide methods in determining appropriate force need to open and close a door in a given environment. The force Fₛ is the force from the spring being pushed down by the linear actuator above the motorized wheel. This spring force can be adjustable based on the spring stiffness k and by the linear actuator displacing the spring δx according to an algorithm that can include but is not limited to Hooke's Law:

$${F}_{s} = k * δ x$$

This spring force can be calibrated by using a linear actuator 103 with a displacement sensor, using a load cell force sensor, or measuring the current in the linear actuator to link the current to the linear force. The system can determine the friction force F_{f} c by the coefficient of friction μ of the wheel with respect to the floor surface based on the normal force N which is equal to the spring force Fₛ:

$${F}_{f} = μ * N = μ * {F}_{s}$$

The motor torque T required to spin the motorized wheel with wheel radius r can be expressed as and determined using:

$$T = {F}_{f} * r = μ * {F}_{s} * r = μ * k * δ x * r$$

The force F that the motorized wheel will pull on the door to open or close it will be:

$$F = {F}_{f} = μ * {F}_{s} = μ * k * δ x$$

These governing equations allow the selection of a motor torque T and door pulling force F based on the system design parameters which include the wheel radius r, spring stiffness k, spring deflection from the linear actuator δx, and the coefficient of friction μ of the wheel relative to the floor surface. To calculate the required wheel motor torque with respect to the door opening force, then the equations can be simplified to:

$$T = F * r$$

For example, if the desired door opening force is or determined to be 5 lb. for an interior door according to the ADA standards and a 2.5 in diameter wheel is used in this mechanism which is mounted below the door handle, then the required motor torque can be determined by the system as:

$$T = F * r = 5 lbf * \frac{2.5}{2} in = 6.25 lbf * in = 0.71 N * m$$

0.71 N*m is a reasonable torque that can be achieved with a typical geared DC motor or other motor types. Since the mechanism is designed to be mounted directly below a typical door handle, the apparatus of the present disclosure has a greater mechanical advantage than conventional door openers mounted above the door near the door hinges. The system 1 can also correct for slippage on the floor. To ensure the no-slip condition, then a spring stiffness k, deflection δx, and coefficient of friction μ can be designed to achieve a spring force that keeps the wheel in contact with the ground. For example, if the spring stiffness k is 10 lbf/in and the coefficient of friction is at least 0.5, then the spring deflection δx can be calculated as:

$$δ x = \frac{5 lbf}{0.5 * 10 \frac{lbf}{in}} = 1 in$$

A deflection of 1 in for a biasing means with a stiffness of 10 lbf/in can be readily achieved with conventional coil compression and extension springs. This spring deflection would ensure that the no-slip condition is met if the door opening force is 5 lbf or less. If more door opening force is required, such as up to 10 lbf needed for many external doors according to ADA standards, then the system can re-calculated to determine a higher door opening forces:

$$\begin{matrix}T = F * r = 10 lbf * \frac{2.5}{2} in = 12.5 lbf * in = 1.41 N * m \\ δ x = \frac{10 lbf}{0.5 * 10 \frac{lbf}{in}} = 2 in\end{matrix}$$

In some exemplary embodiments, the door opening system design requires the spring force to be dynamically adjustable by using a linear actuator to deflect the spring-loaded motorized wheel to achieve the no-slip condition and open a door with the required force based on standards. This allows the mechanism to work for interior and exterior doors. Further, the system has a built-in safety mechanism when a person or an obstacle gets in the way of the door while it is opening or closing. The adjustable spring force provided by the linear actuator ensures that the mechanism force won't be able to exceed the maximum opening force because the wheel will slip and start to slide if the force exceeds the target door opening force. When the system is done being used, the linear actuator can readily pull the motorized wheel up out of contact with the ground, which results in an automatic door system that offers no resistance to users opening the door manually without activating the system.

In some exemplary embodiments, when that the motor selected can spin at ω=80 rpm, or 8.38 rad/s, and the torque T=1.41 N*m, the max power required for this door opener mechanism can be calculated as:

$$P = ω * T = ( 8.38 \frac{rad}{s} ) * ( 1.41 N * m ) = 1 1.82 W$$

This is a relatively low power requirement because this door opener mechanism has a good mechanical advantage to open a door as compared to traditional overhead door openers with a poor lever arm that requires a large gear ratio. The max door opening speed with this motor speed can also be determined by starting with the equations for the door distance travel needed:

$$s = L θ$$

Where L is the door length, which is typically 3 ft or 0.914 m. If the door needs to open 90 degrees, or pi/2, then this can be simplified to:

$$s = L * \frac{π}{2}$$

The average time required to travel the distance s at linear velocity v is given by:

$$t = \frac{s}{v}$$

The linear speed v is the speed at the center of the wheel and can be related to the wheel's angular velocity using:

$$v = r ω$$

Combining the last three equations gives the theoretical min. time required to open the door, assuming a constant speed with a short acceleration period:

$$t = \frac{π L}{2 ω r}$$

As an example calculation, we can assume the same parameters as before with ω=80 rpm, or 8.38 rad/s, torque T=1.41 N*m, door length L=0.914 m, and r=2.5 in or 0.0635 m:

$$t = \frac{π ( 0.9 \; 14 m )}{2 ( 8.38 rad / s ) ( 0.0 \; 635 m )} = 2.7 s$$

This can establish a theoretical minimum door opening time if the 80 rpm motor is driven at max speed and the acceleration and deceleration time is assumed to be very short. The system 1 can establish such a theoretical minimum door opening time for a reasonable motor speed for design purposes and various applications. The motor can be run at lower speeds by controlling the PWM duty cycle.

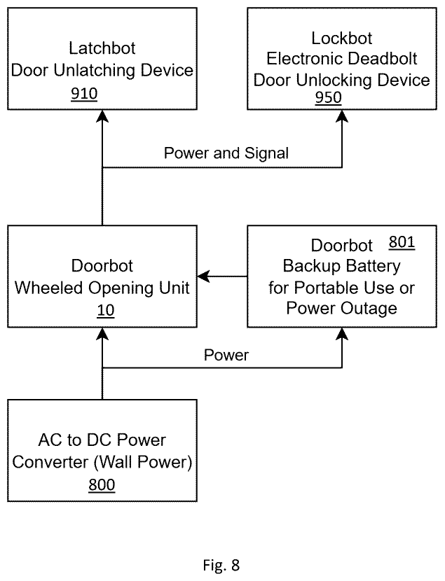

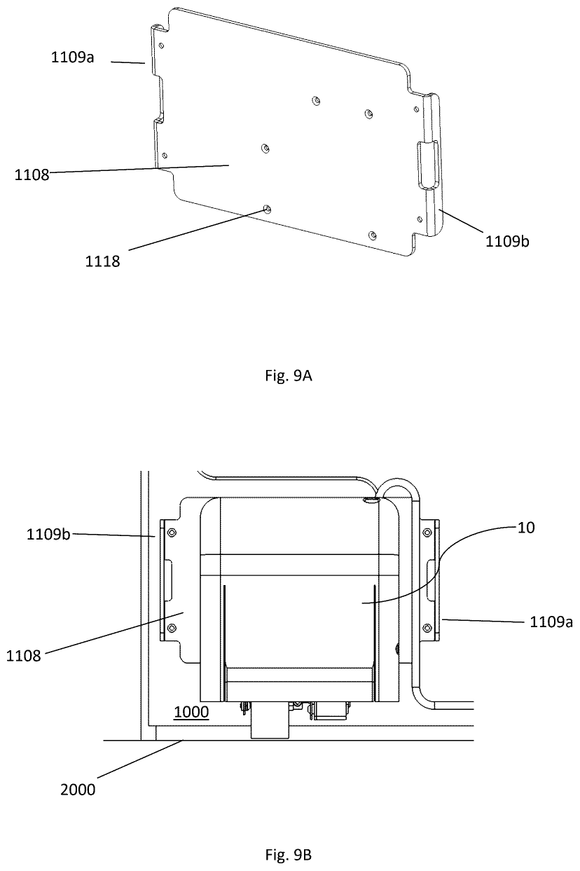

As shown in FIGS. 9A-B, the door opener 1 may further comprise a semi-permanent or permanent back mounting plate 1108 configured to secure the door opener 1 to a door 1000 while accommodating existing door hardware and weather sealing. The mounting plate can have one or more apertures 1118 to attach the plate 1108 to the door. The plate can be a tape and screw hybrid and may have a smooth surface area and optimized for heavy-duty, double-sided tape (for semi-permanent installation) alongside integrated countersunk screw holes (for permanent installation in wood or metal doors. To avoid the strong double-sided tape damaging doors upon removal, the wide metal mounting plate includes specific handle features 1109 on each far side (the short ends). These handles 1109 can be grabbed by a hand or an inserted tool to torque the plate off the door. Pulling from the short ends of the wide plate allows the tape to peel and release slowly, safely disengaging without damaging the door's surface. The mounting plate 1108 and door opener 1 connection is specifically contoured to have a vertical and horizontal offset distance from the bottom of the door to route around existing weather-stripping mounting plates on the inside of the door, allowing the door opener 1 to sit flush above the mounting plate 1108 without compromising the door's thermal/environmental seal.

The apparatus 10 may further comprise a friction clamping mount system, providing a secondary mounting option via a clamp mount 1110 configured to allow users to attach the door opener 1 to the door 1000 purely via mechanical friction as provided in FIGS. 10A-C. This prevents the need for tape or drilling altogether so the system 1000 can be easily added and removed with minimum intrusion to the current door 1000. The clamp mount 1110 comprises adjustable screws 1111 and rubber feet 1112. The screws 1111 are located and configured to push directly against the surface of the door 1000, pulling the clamp mount 1110 tightly under the side or bottom of the door to hold the door opener 1 securely in place via friction. A bottom plate 1115 can have a bottom portion 1116 and first sidewall extending 1117 extending from the bottom portion 1116 and a second sidewall 1118 extending from the bottom portion as shown in FIG. 10A. A mounting plate 1120 can be coupled through the same screws 1111 or other fasteners to the second sidewall 1118 or formed as part of the sidewall 118 and provide a mounting location for the wheel apparatus 10. Since edge-clamping can interfere with an exterior door's natural seal, the clamp mount 1110 could replace the existing weather stripping in that specific area of the door 1000 with its own integrated “clamped runner” ensuring the door remains properly sealed while the clamp 1110 is installed.

The system may interact with other devices and networks to communicate with the client(s). Hardware may include video cameras, microphones, video players, cameras, and accessing other apps or software for communicating and transferring data to update the display output. The output may then be modified with hardware data capture information. Such as using the camera to capture video and displaying the video in real-time on the output display, including audio played over speakers.

Other networks may be in communication with the system, such as a network of service providers and information related to providing services. Other networks and other applications, such as accessing a calendar to determine availability and scheduling the service appointment. Navigation may be accessed to help with directions to where the service is to be provided.

The client may provide an interface to other devices including, without limitation, servers, other clients, printers, database servers, print servers, file servers, communication servers, distributed servers, and the like. Additionally, this coupling and/or connection may facilitate remote execution of program across the network. The networking of some or all of these devices may facilitate parallel processing of a program or method at one or more location. In addition, any of the devices attached to the client through an interface may include at least one storage medium capable of storing methods, programs, applications, code, and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM, and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other network types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players, and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

While certain illustrative embodiments have been described in detail in the drawings and the foregoing description, such an illustration and description are to be considered as exemplary and not restrictive in character, it being understood that only illustrative embodiments have been shown and described and that all changes and modifications that come within the spirit of the disclosure are desired to be protected. There are a plurality of advantages of the present disclosure arising from the various features of the apparatus, systems, and methods described herein. It will be noted that alternative embodiments of the apparatus, systems, and methods of the present disclosure may not include all of the features described yet still benefit from at least some of the advantages of such features. Those of ordinary skill in the art may readily devise their own implementations of the apparatus, systems, and methods that incorporate one or more of the features of the present invention and fall within the spirit and scope of the present disclosure.

What is claimed is:

1. A door opening system, comprising:
a door opening apparatus, comprising:
a housing configured to be mounted to a door;
a linear actuator assembly comprising:
a mounting frame;
a biasing means; and
a linear actuator configured to move the linear actuator assembly between a first position and a second position;
a wheel assembly comprising:
a wheel housing member and a wheel, wherein a portion of the wheel housing member is coupled to the linear actuator assembly, wherein the wheel assembly moves between the first position and the second position driven by the linear actuator;
a drive motor assembly having a drive motor configured to drive the wheel around an axis, wherein the drive motor assembly is coupled to a portion of the wheel assembly, wherein the drive motor assembly moves along a vertical axis when the linear actuator extends between the first position and the second position; and
a controller comprising a microprocessor and a memory, the controller communicatively coupled to the linear actuator and the drive motor, wherein the controller is configured to calculate a required force for opening or closing the door based on at least a spring stiffness of the biasing means, a deflection of the biasing means controlled by the linear actuator, and a coefficient of friction between the wheel and the ground surface.

2. The system of claim 1, further comprising a linear potentiometer or linear variable differential transformer (“LVDT”) communicatively coupled to the controller and configured to monitor an extension position of the linear actuator in real time, wherein the controller adjusts the deflection of the biasing means based on position data from the linear potentiometer or LVDT.

3. The system of claim 2, wherein the controller is configured to implement a safety algorithm in which the biasing means deflection is calibrated such that the wheel slips on the ground surface when a force applied to the door exceeds a target door opening force, thereby preventing the apparatus from applying excessive force against a person or obstacle.

4. The system of claim 3, further comprising one or more sensors selected from the group consisting of: a limit switch configured to detect external objects within a proximity of the apparatus, a wheel rotary position encoder, a current sensor configured to detect current delivered to the drive motor, an inertial measurement unit configured to detect the door angle and speed of rotation, and a door angle sensor.

5. The system of claim 4, wherein the controller is configured to operate in at least one of a timed opening mode in which the door remains open for an adjustable amount of time and a toggle mode in which the door remains open until a close signal is received.

6. The system of claim 5, wherein the controller is communicatively coupled to one or more external devices via at least one of a wired connection, a wireless radio frequency connection, Wi-Fi, Bluetooth, Zigbee, and an IoT interface, and the apparatus is further controllable via voice control.

7. The system of claim 6, wherein the controller monitors, in real time, a position of the linear actuator using a linear position sensor, and adjusting the displacement of the biasing means to maintain a no-slip condition between the wheel and the ground surface.

8. The system of claim 7, wherein the controller detects an obstacle condition based on at least one of a motor current exceeding a threshold, a limit switch activation, or an inertial measurement unit detecting a deviation from an expected door speed profile, and in response, stopping or reversing the drive motor and retracting the wheel.

9. The system of claim 8, further comprising at least one door opening subsystem selected from the following:
an unlatching door subsystem, a door handle unlatching subsystem, and an electronic deadbolt subsystem.

10. The system of claim 9, wherein the door opening apparatus distributes electrical power from the door opening apparatus to at least one door opening subsystem mounted on the door via a wiring path, and providing backup power to the at least one door opening subsystem from an internal battery of the door opening apparatus upon interruption of a primary power source.

11. A door opening apparatus comprising:
a housing configured to be mounted to a door;
a spring-loaded wheel assembly comprising a biasing means, a linear actuator, and a wheel, the wheel assembly movable between a retracted position and an engaged position in contact with a ground surface;
a drive motor configured to rotate the wheel;
an inertial measurement unit (IMU) configured to continuously monitor the door's angular position relative to a closed position and angular velocity; and
a controller communicatively coupled to the drive motor and the IMU, the controller configured to:
detect, via the IMU, a sudden deceleration or deviation from an expected angular speed profile during a door opening or closing operation, and in response, stop the drive motor to prevent the door from applying force against a person or obstacle;
detect, via the IMU, that a user is pushing the door in an opening direction while the apparatus is engaged, and in response, drive the wheel motor to assist the user in opening the door to a maximum angle limit; and
detect, via the IMU, that a user is pushing the door in a closing direction, and in response, drive the wheel motor to assist the user in closing the door to the fully closed position.

12. A door opener apparatus comprising:
a housing configured to be mounted to a door;
a linear actuator assembly comprising:
a mounting frame;
a biasing means; and
a linear actuator configured to move the linear actuator assembly between a first position and a second position;
a wheel assembly comprising:
a housing member; and a wheel, wherein a portion of the housing member is coupled to the linear actuator assembly, wherein the wheel assembly moves between the first position and the second position with the linear actuator; and
a drive motor assembly comprising:
housing member and a drive motor configured to drive the wheel around an axis, wherein the drive motor assembly is coupled to a portion of the wheel assembly, wherein the drive motor assembly moves along a vertical axis when the linear actuator extends between the first position and the second position.

13. The apparatus of claim 12, further comprising a controller comprising a microprocessor, a memory, and a transceiver, wherein the controller is communicatively coupled to the linear actuator and drive motor.

14. The apparatus of claim 13, further comprising a first sensor, wherein the first sensor is a limit switch configured to detect external objects within a predetermined proximity of the apparatus.

15. The apparatus of claim 14, further comprising a second sensor, wherein the second sensor is a wheel rotary position sensor configured to track the rotary position and speed of the wheel as it moves.

16. The apparatus of claim 15, further comprising a third sensor, wherein the third sensor is a linear potentiometer configured to monitor the position of the linear actuator.

17. The apparatus of claim 16, further comprising a fourth sensor, wherein the fourth sensor is a door angle sensor configured to detect the door position and speed of rotation when the wheel assembly moves the door between a first position and a second position.

18. The apparatus of claim 17, wherein the controller is communicatively coupled to the one or more sensors and utilizes the data to optimize the performance of the door opening apparatus during operation.

19. The apparatus of claim 18, wherein linear actuator movement and drive motor movement is determined by the environmental data acquired by one or more sensors.

20. The apparatus of claim 19, wherein the environmental data can include wheel radius r, spring stiffness k, spring deflection from the linear actuator δx, and the coefficient of friction μ of the wheel relative to the floor surface.
